(19) United States
(12) Patent Application Publication
(10) Pub. No.: US 2005/0086919 A1
(43) Pub. Date: Apr. 28, 2005

(54) WOBBLE DRIVE FOR WINDROWER HEADER

(76) Inventors: Thomas L. Stiefvater, Ephrata, PA (US); Barry E. Smith, Ephrata, PA (US); Edward A. Blakeslee, Ephrata, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 10/695,097

(22) Filed: Oct. 28, 2003

(51) Int. Cl. A01D 69/00

(52) U.S. Cl. 56/10.8

(57) ABSTRACT

A wobble drive system for a reciprocating cutter bar. The wobble drive is of an open streamlined design and employs precision components which do not require assembly shimming and adjustment.

### BACKGROUND OF THE INVENTION

This invention relates generally to headers for crop-harvesting machines, and more particularly to a sickle bar header forming a part of what is generally know in the agricultural business as a swather or windrower. Even more particularly, the instant invention relates to the use of a modular wobble drive for a reciprocating sickle bar mower of a crop harvester.

In modern agriculture, especially in regard to harvesting forage crops, it is the present tendency to cut a relatively wide swath of the crop within a range of anywhere between ten and sixteen or more feet in width, and then consolidate the crop into a narrower, substantially continuous windrow, in which form the crop is left to dry in the field until the moisture content has been reduced to a value suitable for subsequent harvesting operations such as, for example, baling. The arranging of the crop into a continuous windrow around the field is primarily to facilitate the baling or other packaging thereof.

There are many different types and designs of windrowers, such as, for example, pull type, which are pulled behind a tractor, and self-propelled type, which are connectable to the forward end of a specialized tractor. When these windrowers are fitted with sickle bar mowers, the instant invention can be employed in the drive system to improve operational and other characteristics. Likewise, the instant invention can be advantageously employed with any other type of sickle drive, whether it be in a simple mower or a more complex combine header.

The most common designs of windrower headers employ a crop cutting mechanism across the lower front of the header to sever the crop from the field, a rotating reel to receive the cut crop material and convey it rearwardly to a consolidating mechanism, such as an auger, where the crop is moved centrally of the header from either lateral end portion thereof for feeding into a crop-conditioning mechanism, conditioning rolls, for instance. A header of this type is shown and described in U.S. Pat. No. 3,324,639 issued to L. M. Halls et al. on Jun. 13, 1967.

Typically, the cutting mechanism comprises either a single or double sickle bar, moved in a reciprocating motion across the lower front of the header to shear the standing crop in conjunction with a plurality of sickle guards. The individual sickle bar(s) are usually driven at the outer end thereof by what is commonly referred to as a “wobble” box or drive.

The concept of a wobble box to convert a rotary motion into a horizontal reciprocal motion is not in and of itself new; however, there are problems with current designs that prevent the attainment of optimum efficiency in operation and increase manufacturing and service costs. Wobble boxes have heretofore been manufactured and assembled with major components formed as a part of the header frame. This non-modular, or integrated, design makes field service and repair not only more difficult (because the mechanic must work on the components from the bottom of the header), but also increases the time necessary to make repairs, increasing costs and subjecting crops to potential losses during the harvesting process.

Another problem encountered with current designs is that of shimming and adjustment. Non-precision bearings and components decrease the initial cost of a wobble box, but make manufacturing assembly and field repairs more time-consuming and costly. It requires skill, patience and time to properly shim and adjust current wobble boxes, and if not done properly, subjects the wobble box and drive system to unnecessary and undesirable forces and early failure.

Many current wobble box designs are enclosed for lubrication and cleanliness. Such designs are bulky and run down uncut crop materials alongside of the cutterhead. This, of course, can reduce the yield of the harvesting operation and cost money.

It would be helpful to have a streamlined modular drive system of the type herein described capable of handling the excessive inertia and cyclical loading encountered by a wobble drive system during field operations and overcoming the various problems identified above. The instant invention provides such an alternative.

### SUMMARY OF THE INVENTION

Accordingly, one object of the present invention is to provide an improved alternative mechanism for driving the sickle bar(s) of an agricultural harvesting header.

Another object of the present invention is to provide an improved wobble drive mechanism with improved capabilities to withstand the cyclical and inertia loads during field operations.

It is another object of the instant invention to provide a modular wobble drive mechanism which uses precision made components that do not require shimming or adjustment during assembly, making more cost effective the assembly process and future servicing.

Yet another object of the present invention is to provide a modular wobble drive mechanism with high precision tapered roller bearings that can be fitted into precision machined shoulders to minimize looseness.

It is yet another object of the present invention to provide an improved modular wobble drive mechanism that supports precision machined shoulders for the bearing outer races to provide correct rolling clearance for the bearings.

It is a still further object of the instant invention to provide a modular wobble drive mechanism with a stream-lined modular construction to minimize crop run-down.

It is an even still further object of the instant invention to provide a modular open design wobble drive mechanism that can be fully bench-assembled, run-in, and serviced as an assembly and which is durable in construction, relatively inexpensive to manufacture, carefree of maintenance, facile in assemblage, and simple and effective in use.

These and other objects are achieved by providing a wobble drive system for a reciprocating cutter bar. The wobble drive is of an open streamlined design and employs precision components which do not require assembly shimming and adjustment.

### DESCRIPTION OF THE DRAWINGS

The advantages of this invention will be apparent upon consideration of the following detailed disclosure of the invention, especially when taken in conjunction with the accompanying drawings wherein:

FIG. 1 is a side elevational view of a windrow harvesting machine with which the instant invention can be used;

FIG. 2 is an exploded view of the wobble drive mechanism of the instant invention; and

FIG. 3 is a partial bottom plan view of the cutting mechanism, taken along line 3-3 of FIG. 1, showing a double sickle drive employing the wobble drives of the instant invention.

### DESCRIPTION OF THE PREFERRED EMBODIMENT

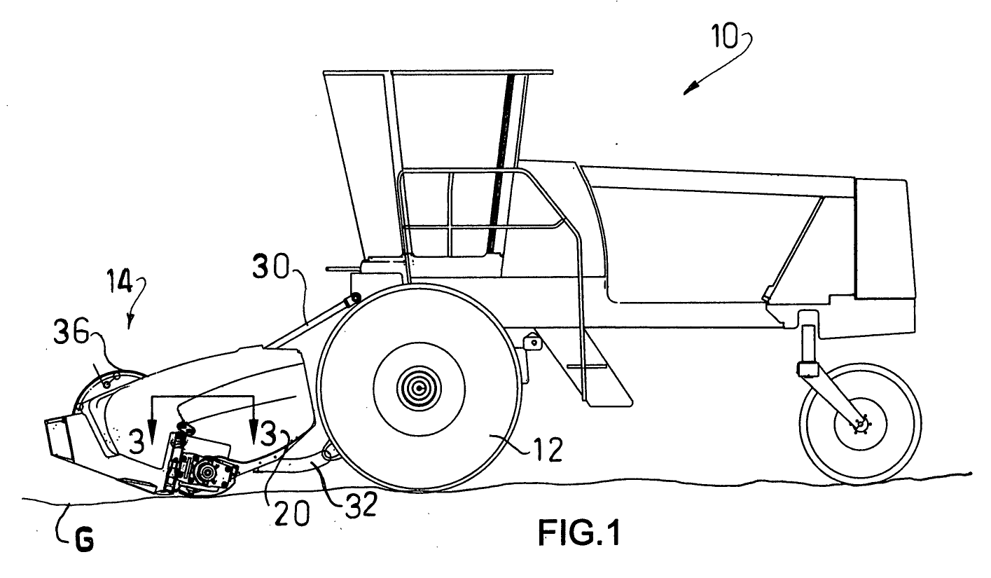

Referring particularly now to FIG. 1, the forward portion of a tractor 10 is shown to include a pair of transversely spaced driving wheels 12 that provide the principal support not only for the tractor, but also the header mechanism 14 and a conditioner unit which are, respectively, independently supported by the forward portion of the tractor 10 by means to be described hereinafter. As one knowledgeable in this technology would readily understand, tractor 10 and header 14 are generally symmetrical about a central vertical longitudinal plane. Thus, while pairs of wheels, such as 12, and other components are described, only one is shown in the FIG. 1 side elevational view.

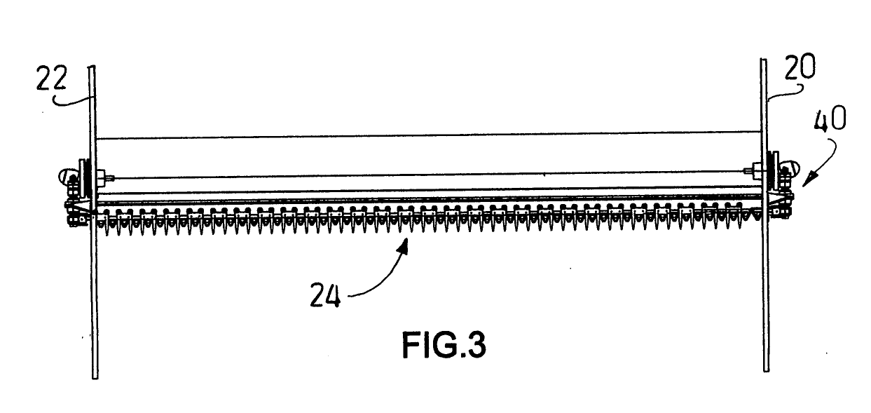

The header 14 comprises a main frame of substantial width to permit the header to harvest a swath of forage crops, or the like, of a substantial range of different widths within the range, for example, of between ten and sixteen or more feet. Particularly where the forage crop does not grow to substantial heights, it is more efficient and economical to cut a relatively wide swath of said material and then consolidate the same into a substantially narrowed windrow in which form the crop dries and from which it is fed to subsequent portable packaging equipment. The main frame has opposite sides 20 and 22, which are of substantial length, extending forwardly from the tractor 10. The main frame is supported preferably for floating substantially vertical movement to enable the sickle bar assembly 24 (FIG. 3) normally to be positioned close to the exemplary ground surface G by the employment of skids or shoes (not shown) which are fixed to the main frame at opposite sides thereof. The sickle bar assembly 24 also extends between the opposite sides of the main frame so as to cut a swath of material substantially equal to the width of the main frame.

The main frame is connected to and supported by the forward end of the tractor 10 by pairs of heavy links 30 and 32 which respectively extend from opposite sides of the tractor 10; the links of each pair being spaced vertically one above the other. By such arrangement of substantially parallel upper and lower links 30 and 32, the vertical movement of the header 14 with respect to the tractor 10 will be permitted while the header remains generally horizontal in all vertical positions of operation. The full supporting structure is well known in the art, as generally shown by U.S. Pat. No. 3,324,639.

In the preferred mounting of the header 14 with respect to the forward end of tractor 10, although the header normally substantially rides upon the skid shoes which slide over the ground, the full weight of the header is by no means sustained by the skid shoes in that appropriate tensioning means, such as springs (not shown), extending from the forward end of tractor 10 to carry the majority of the weight of the header 14. Further, fragmentary link means are intended to exemplify an elevating mechanism, not shown in detail, but supported by the forward portion of tractor 10 and arranged to be operated to move the header 14 from its lowermost operative position, as illustrated generally in FIG. 1, to various elevated positions. Such tensioning and elevating mechanisms are not an essential part of the present invention and thus details are not believed to be necessary.

To facilitate the movement of crop material toward the sickle bar assembly 24, a conventional reel 36 extends between the opposite sides of main frame and is rotatably supported for movement about an axis fixed with respect to main frame. The reel preferably is of the type having rows of tines extending from pivoted rods actuated by cams in the ends of the reel to cause the rows of tines to produce a sweeping-like motion that rakes and impels the cut crop material up toward the auger consolidating means, and then release the material, just before engagement by the auger.

Also supported by main frame rearwardly of the reel 36, upwardly from and rearwardly of the sickle bar assembly 24, is an auger (not shown), the axis of which is substantially parallel to that of reel 36 and the auger extends between the opposite sides of the frame. The auger comprises a central tube and coaxial therewith at opposite ends are axle means which allow the auger to rotate. The various elements of the header not shown herein are well known in the agricultural industry and can be clearly seen in, among others, the patents cited above.

The input drive for the sickle bar assembly 24 can be of any conventional type such as, for example, mechanical or hydraulic. Such drives may be single or double, depending upon the type of header, its length and the crops to be harvested. Exemplary drives are shown in U.S. Pat. Nos. 6,305,154 and 4,216,641. The drive mechanism does not form a significant part of this invention, and is not shown in detail herein.

The primary contribution of the instant invention is a wobble drive which is modular in construction and uses precision components requiring no assembly adjustment. This is significant in providing improved manufacturing processes and operational characteristics. The drive components are designed with minimal looseness, which is required by the nature of the reciprocating loading encountered in a reciprocating drive.

High precision bearings are another unique and important feature of this wobble drive. The wobble mechanism uses tapered roller bearings which are made to a very narrow tolerance range (higher than normal pre-set bearings, which can and must be adjusted and shimmed) to minimize looseness. In this design, the housings which support the bearing outer races have precision-machined shoulders to provide the correct rolling clearance for the bearings.

Another feature of the instant wobble drive is the streamlined profile modular construction. As a modular construction, the wobble mechanism can be fully bench-assembled, run-in, and serviced as an assembly, and the streamlined design offers the advantage of minimizing crop run-down.

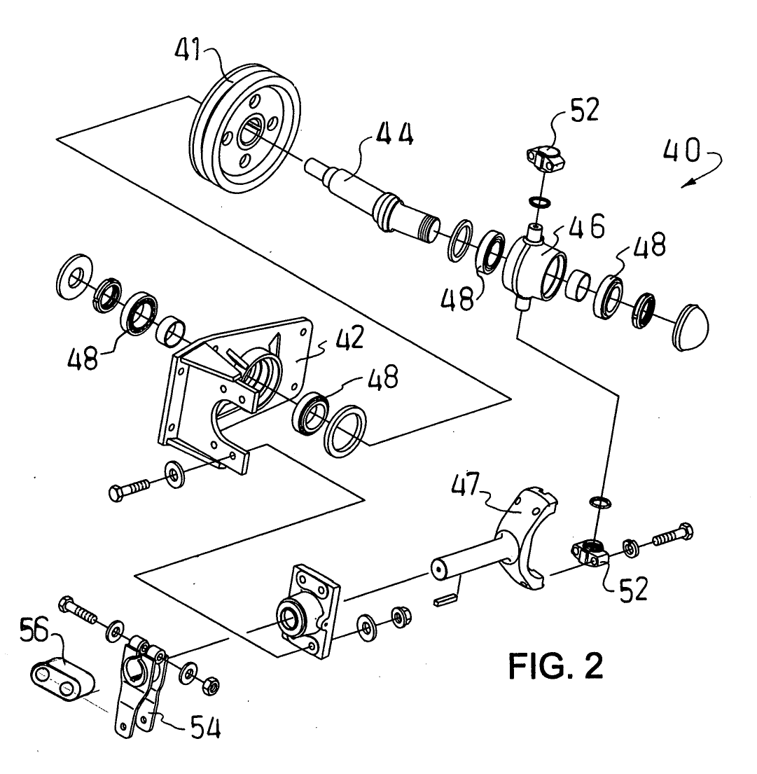

Referring now to FIG. 2, the instant wobble drive is shown in exploded view. Wobble drive 40 is comprised of main components: housing 42, wobble shaft 44, wobble hub 46, and wobble yoke 47. Continuous rotation of the wobble shaft 44 provides angular reciprocation of the wobble yoke 47 by means of the wobble shaft 44 “bent-axis” and the wobble hub 46. High precision tapered roller bearing assemblies 48 are used to carry the wobble shaft 44 in the housing 42 and to support the wobble hub 46 on the wobble shaft 44. Precision needle bearings 52 are used to connect the wobble yoke 47 to the wobble hub 46. The wobble yoke 47 is coupled to a link 54 and a connecting rod 56 to drive long pivoting rocker arms (not shown) which provide a nearly linear motion to the sickle knife (not shown). Input in this embodiment is provided by a belt (not shown) driving sheave 41 which is, in turn, affixed to wobble shaft 44. Sheave 41 and the belt that drives it operate in a plane generally parallel to the side 20 of header 14. It is the purpose of the wobble drive to convert that rotational motion to a reciprocating motion, driving the sickle bar(s). In general, this concept is known in the art, but the concept of precision bearings and precision machined shoulders is not known in the prior art.

A requirement of the wobble mechanism is that the axes of the wobble shaft 44, wobble hub 46 and wobble yoke 47 intersect. The wobble components must be precision machined to guarantee axes intersection. Failure of the described axes to intersect results in misalignment which causes undue wear and loading. In addition, the bearings used in the assembly must be precision components to avoid axial and radial looseness. The precision machining of the components provides for adjustment-free assembly by assuring that this alignment requirement is met and maintained. In particular, the bearing mounting surfaces are precision machined to provide pre-set (within a narrow tolerance range) clearances for the precision tapered roller bearing assemblies.

In summary, the wobble drive is precision machined and sealed to accept precision bearings with minimum clearances, providing an assembly (and repair) process that does not require shims or adjustment to attain maximized alignment of critical component axes. Furthermore, a streamlined open design reduces the possibilities of crop run-down.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the inventions. For instance, the improved wobble drive is shown herein in use with a self-propelled drive mechanism; however, the wobble drive could be used equally satisfactorily with a pull-type mower or mower-conditioner. Accordingly, the following claims are intended to protect the invention broadly as well as in the specific form shown.

1. A crop-harvesting header arranged to be supported by the forward end of a tractor and comprising in combination:
a main frame of substantial width and having a front end and opposing rear end, an upper portion and an opposing lower portion, and opposing lateral sides;
a mechanism attachable to a tractor and connected to said main frame to support said main frame for vertical movement relative to the ground;
a sickle bar assembly including at least one sickle bar, said assembly supported by the lower portion of said frame and extending between said lateral sides thereof to cut a swath substantially as wide as said main frame;
a consolidating auger extending horizontally between said lateral sides of said main frame, said auger having oppositely spiraled helical flights extending inwardly from opposite ends thereof and a central axial shaft about which said auger rotates;
an arcuate shield adjacent the lower and rearward portions of said auger to guide cut and consolidated crop material rearwardly; and
a modular wobble drive removably affixed to one of said lateral sides and said at least one sickle bar and comprising:
an open housing having a first opening therethrough with a first pair of precision machined bearing shoulders on each side of said first opening;
a bent-axis wobble shaft extending through said first opening and supported therein by a first pair of precision bearings, one fitted within each of said first pair of precision machined bearing shoulders, said bent-axis wobble shaft having a first and a second shaft portion, each with a longitudinal axis, the two of which intersect but are not parallel;
a wobble hub having an elongate tube-shaped body with a central axis and a second pair of precision machined bearing shoulders paced apart along said central axis;
said second shaft portion of said bent-axis wobble shaft extending through said tube-shaped body of said wobble hub and supported therein by a second pair of precision bearings, one fitted within each of said second pair of precision machined bearing shoulders;
said tube-shaped body of said wobble hub further having a pair of opposing precision machined bearing surfaces protruding from the outer surface of said body;
a Y-shaped wobble yoke with the cupped portion fitting part way around said tube-shaped body of said wobble hub and movably supported thereto by a third pair of precision bearings, one affixed to each of said bearing surfaces, the leg portion supported by a single precision bearing affixed to said open housing;
said open housing, bent-axis wobble shaft, wobble hub and wobble yoke so arranged that rotation of said first portion of said bent-axis wobble shaft results in reciprocating movement of said leg portion of said wobble yoke.

2. The crop-harvesting header of claim 1, wherein:
said first and second pairs of precision bearings are tapered roller bearings.

3. The crop-harvesting header of claim 2, wherein:
said third pair of precision bearings are needle bearings.

4. The crop-harvesting header of claim 3, wherein:
Said sickle bar assembly includes two opposing sickle bars, each with its own modular wobble drive.

5. In a crop-harvesting header arranged to be supported by the forward end of a tractor, said header comprising:
a main frame of substantial width and having a front end and opposing rear end, an upper portion and an opposing lower portion, and opposing lateral sides;
a mechanism attachable to a tractor and connected to said main frame to support said main frame for vertical movement relative to the ground;
a sickle bar assembly including at least one sickle bar, said assembly supported by the lower portion of said frame and extending between said lateral sides thereof to cut a swath substantially as wide as said main frame;
a consolidating auger extending horizontally between said lateral sides of said main frame, said auger having oppositely spiraled helical flights extending inwardly from opposite ends thereof and a central axial shaft about which said auger rotates;
an arcuate shield adjacent the lower and rearward portions of said auger to guide cut and consolidated crop material rearwardly; and
a modular wobble drive removably affixed to one of said lateral sides and said at least one sickle bar, the improvement in said wobble drive comprising:
an open housing having a first opening therethrough with a first pair of precision machined bearing shoulders on each side of said first opening;
a bent-axis wobble shaft extending through said first opening and supported therein by a first pair of precision bearings, one fitted within each of said first pair of precision machined bearing shoulders, said bent-axis wobble shaft having a first and a second shaft portion, each with a longitudinal axis, the two of which intersect but are not parallel;
a wobble hub having an elongate tube-shaped body with a central axis and a second pair of precision machined bearing shoulders paced apart along said central axis;
said second shaft portion of said bent-axis wobble shaft extending through said tube-shaped body of said wobble hub and supported therein by a second pair of precision bearings, one fitted within each of said second pair of precision machined bearing shoulders;
said tube-shaped body of said wobble hub further having a pair of opposing precision machined bearing surfaces protruding from the outer surface of said body;
a Y-shaped wobble yoke with the cupped portion fitting part way around said tube-shaped body of said wobble hub and movably supported thereto by a third pair of precision bearings, one affixed to each of said bearing surfaces, the leg portion supported by a single precision bearing affixed to said open housing;
said open housing, bent-axis wobble shaft, wobble hub and wobble yoke so arranged that rotation of said first portion of said bent-axis wobble shaft results in reciprocating movement of said leg portion of said wobble yoke.

8. The crop-harvesting header of claim 7, wherein:
said first and second pairs of precision bearings are tapered roller bearings.

9. The crop-harvesting header of claim 8, wherein:
said third pair of precision bearings are needle bearings.

10. The crop-harvesting header of claim 9, wherein:
Said sickle bar assembly includes two opposing sickle bars, each with its own modular wobble drive.

11. A modular wobble drive for a sickle bar crop harvesting mechanism, comprising:
an open housing having a first opening therethrough with a first pair of precision machined bearing shoulders on each side of said first opening;
a bent-axis wobble shaft extending through said first opening and supported therein by a first pair of precision bearings, one fitted within each of said first pair of precision machined bearing shoulders, said bent-axis wobble shaft having a first and a second shaft portion, each with a longitudinal axis, the two of which intersect but are not parallel;
a wobble hub having an elongate tube-shaped body with a central axis and a second pair of precision machined bearing shoulders spaced apart along said central axis;
said second shaft portion of said bent-axis wobble shaft extending through said tube-shaped body of said wobble hub and supported therein by a second pair of precision bearings, one fitted within each of said second pair of precision machined bearing shoulders;
said tube-shaped body of said wobble hub further having a pair of opposing precision machined bearing surfaces protruding from the outer surface of said body;
a Y-shaped wobble yoke with the cupped portion fitting part way around said tube-shaped body of said wobble hub and movably supported thereto by a third pair of precision bearings, one affixed to each of said bearing surfaces, the leg portion supported by a single precision bearing affixed to said open housing;
said open housing, bent-axis wobble shaft, wobble hub and wobble yoke so arranged that rotation of said first portion of said bent-axis wobble shaft results in reciprocating movement of said leg portion of said wobble yoke.

12. The crop-harvesting header of claim 11, wherein:
said first and second pairs of precision bearings are tapered roller bearings.

13. The crop-harvesting header of claim 12, wherein:
said third pair of precision bearings are needle bearings.

14. The crop-harvesting header of claim 13, wherein:
said sickle bar assembly includes two opposing sickle bars, each with its own modular wobble drive.
